(19) United States
(12) Patent Application Publication
(10) Pub. No.: US 2026/0008555 A1
(43) Pub. Date: Jan. 8, 2026

(54) METHOD FOR OPTIMIZING THE ENERGY MANAGEMENT OF AN AERONAUTICAL ASSEMBLY TO REDUCE GREENHOUSE GAS EMISSIONS AND ASSOCIATED DIGITAL PLATFORM

(71) Applicant: REVIMA GROUP, RIVES-EN-SEINE (FR)

(72) Inventors: MARIE-LAURE BOURGUEIL, RIVES-EN-SEINE (FR); JEAN-PHILIPPE BEAUJARD, RIVES-EN-SEINE (FR); OLIVIER HODAC, RIVES-EN-SEINE (FR); MAGDALENA TRZECIAKOWSKA, RIVES-EN-SEINE (FR); CHRISTOPHE MICHEL, RIVES-EN-SEINE (FR); XAVIER MORNAND, RIVES-EN-SEINE (FR); OLIVIER HY, RIVES-EN-SEINE (FR); ROMAIN BLANQUET, RIVES-EN-SEINE (FR)

(21) Appl. No.: 19/328,151

(22) Filed: Sep. 14, 2025

Related U.S. Application Data
(63) Continuation-in-part of application No. 17/696,852, filed on Mar. 16, 2022.

(30) Foreign Application Priority Data
Mar. 19, 2021 (EP) 21163751.7

(51) Int. Cl. B64D 31/00; B64D 41/00; B64F 5/40

(52) U.S. Cl. CPC B64D 31/00; B64D 41/00; B64F 5/40

(57) ABSTRACT

A method for optimizing energy management and reducing the greenhouse gas emissions of a complex aeronautical assembly having at least one aircraft and an auxiliary power unit (APU). The method analyzing, in a centralized manner outside the aeronautical assembly, data from the aeronautical assembly to compare at least one state of a parameter of the assembly with a predetermined optimal state of the parameter. The data measured by sensors of the aeronautical assembly are collected. The collected data is transmitted to a digital processing and analysis platform. The data is processed by the platform implementing machine learning algorithms. Information relating to the processed data is displayed on a dashboard accessible via different terminals. The APU is deactivated to decrease greenhouse gas emissions when energy overconsumption and/or APU overrun event is detected.

### RELATED APPLICATIONS

This application is continuation-in-part application of application Ser. No. 17/696,852 filed Mar. 16, 2022, which claims priority from European Patent Application No. 21163751.7 filed Mar. 19, 2021, each of which is incorporated herein by reference in its entirety.

### TECHNICAL FIELD

The present invention belongs to the field of aeronautics, in particular the energy management of an aeronautical assembly comprising at least one aircraft and equipment such as auxiliary power units, and relates more particularly to a method for optimizing the energy management of such an assembly for a reduction of its greenhouse gas emissions (hereinafter “GHG”) and its energy consumption, as well as a digital platform allowing the implementation of such a method.

### BACKGROUND OF THE INVENTION

In an increasingly competitive economic environment, companies must conduct their activities in an ever more efficient and cost-effective manner, especially in highly globalized industries such as aeronautics and commercial and military aviation. Consequently, the inefficiencies which were once tolerated by companies, due to the partitioned nature of customers and suppliers, must now be removed or attenuated so that companies can be effectively competitive in a highly dynamic global marketplace. Furthermore, the growing interest in eco-responsible operations which respect the environment is an additional motivation to minimize the polluting emissions, the unnecessary losses and ensure a reliable and safe method.

In in-service aircraft, such as airliners, many on-board pieces of equipment are subject to continuous supervision and regular maintenance in order to limit the security risk related to a possible malfunction of this equipment.

For example, the auxiliary power units APU are intended to generate energy on board airplanes to allow the ground (stopped engines) to power the different on-board systems by providing electrical and/or pneumatic generations. APUs can also be used in flight. In order to reduce the airplane fuel consumption, GHG emissions or in the case of APU failure, it is necessary to have on the ground, ground power units (power supply, hydraulic pressure) such as GPUs and a starting unit (pneumatic pressure).

In general, the management of the power supply operations of an airplane on the ground requires the intervention of several actors among the MRO companies, the airport operators and the technical ground crew of the airline operating the aircraft.

The multiplication of actors causes a complexity in the intervention and a lack of operational efficiency. Indeed, the involved actors work for the same objective, are often close to each other, but do not effectively share useful information. This results in a waste of time, unnecessary increase in the costs, and GHG emissions which could have been avoided.

In addition, a non-optimized use of the APU/GPU resources is necessarily accompanied by an energy waste, an increase in the operating costs for airlines and unnecessary GHG emissions.

An effective energy management of this equipment, in particular APUs, therefore proves to be necessary in order, on the one hand, to preserve said equipment and avoid premature failures, and on the other hand, to reduce their energy consumption and their polluting emissions.

The document U.S. Pat. No. 10,752,376B2 describes a pre-flight preparation system for an aircraft, comprising one or more power supply modules. An integrated controller is electrically and communicatively coupled to the power modules to supervise and control said modules in order to provide electrical energy to the aircraft subsystems. A mobile device such as a smartphone can be connected to the integrated controller to provide it with preparation instructions prior to the flight of the aircraft and to supervise the state of this preparation prior to the flight. In addition, this document describes a method for preconditioning an aircraft comprising determining a state of charge of an APU and activating an environmental monitoring subsystem to precondition the aircraft by adjusting a current temperature according to a pre-conditioning profile based on one or several parameters from: a target temperature, a target time, a current temperature, an outside air temperature, an amount of energy and a state of charge of the APU.

This solution only uses data specific to a single aircraft and does not allow any global knowledge of the environment in which the aircraft is operating, such as the airport or the state of other aircraft belonging to the same airline, for example.

The document FR3019358B1 describes a method and a device for the optimized global management of an energy network of an aircraft comprising a plurality of energy equipment, characterized in that it comprises a module for selecting at least one optimization objective among a plurality of predetermined objectives, a module for receiving equipment data, a module for receiving aircraft data, and a module for determining operating setpoints of the energy equipment based on equipment data and aircraft data adapted to achieve at least one selected optimization objective.

This solution does not allow anticipating anomalies from the available data, is limited to a single aircraft, similar to the previous solution, and does not offer any intuitive and simplified visualization of the data knowing that one of the major problems in MRO is the complexity of the information provided to the operators, said operators being sometimes induced in error. This solution also does not allow making recommendations for reducing energy consumption and GHG emissions.

Beyond these references, US20190113558 describes a power-management environment with a remote computer system and power-quality/load databases that analyze deviations and generate alerts, but it does not govern auxiliary power unit usage during ground operations nor integrate airport-side external power equipment. US20150134187 relates to APU condition and health monitoring; while it collects APU data for IT processing, it does not provide a cross-fleet operational optimization with real-time recommendations to transition from APU to external ground power. US20090132176 addresses enterprise-level tracking of energy consumption and greenhouse-gas emissions across mobile sources (including airplanes) for compliance and reporting, rather than real-time, sensor-driven decision support at the aircraft-stand level. US20100008267 focuses on predictive maintenance by transforming sensor streams into snapshots for anomaly detection and trend analysis, without coupling such detections to ground-operation decisions aimed at reducing fuel use and emissions.

None of these documents discloses a centralized platform that, at an airline or airport-network scale, continuously acquires data from aircraft and external equipment (e.g., GPUs) during turnarounds, uses predictive models to identify energy overconsumption such as simultaneous APU/GPU use, generates real-time multi-channel alerts, and issues actionable recommendations to reduce fuel burn and GHG emissions.

### OBJECT AND SUMMARY OF THE INVENTION

The present invention aims at overcoming the drawbacks of the prior art and provides a global solution for optimizing the energy management and reducing the greenhouse gas emissions of a complex aeronautical assembly comprising at least one aircraft and equipment external to said aircraft, in particular during ground operations. To this end, in a first aspect there is provided a computer-implemented method for optimizing an energy management and reducing greenhouse gas emissions of an aeronautical assembly comprising at least one aircraft having an auxiliary power unit (APU), the method comprising collecting data from the aeronautical assembly, the data comprising data measured by sensors of the aeronautical assembly; transmitting the data collected for analysis, in a centralized manner outside the aeronautical assembly, to a digital processing and analysis platform, external to the aeronautical assembly; processing the data by the digital processing and analysis platform, implementing machine learning algorithms, to compare at least one state of a parameter of the aeronautical assembly with a predetermined optimal state of the parameter and at least one of the following: to predict a non-optimal state of the parameter and to recommend actions in order to bring the state of the parameter as close as possible to the predetermined optimal state, wherein said processing comprises: determining, from the data, a current power-supply state of the aircraft selected from APU-only supply, external power-only supply, and simultaneous APU and external power supply; detecting an energy overconsumption event when the simultaneous supply persists beyond a guard time; and/or detecting an APU overrun when an APU run duration exceeds an expected maximum duration for a recognized maintenance context; and issuing an APU shutdown command associated with the detected event; displaying information relating to the data processed on a dashboard accessible via different terminals; and effecting the APU deactivation by at least one of transmitting, when the aircraft type is configured to accept remote commands, a control signal to an aircraft interface to shut down the APU, and transmitting a shutdown instruction to an authorized ground or flight user terminal and, in response to a received confirmation, issuing the control signal to effect the APU shutdown, so as to decrease the greenhouse gas emissions.

In accordance with an exemplary embodiment of the claimed invention, the collection of the data is carried out in real time and continuously while the aircraft is parked with engines off, the collected data comprising status events and measured values representative of the power supply of the aircraft and of internal and external equipment activity. In accordance with an exemplary embodiment of the claimed invention, the determining of the current power-supply state combines APU status with measurements reported by the aircraft and by at least one external equipment, so as to discriminate between exclusive APU supply, exclusive external power supply, or simultaneous supply. Advantageously, the guard time applied before declaring the simultaneous supply as an energy overconsumption event is configurable and is equal to fifteen minutes. Preferably, the recognized context distinguishes a maintenance context from a passenger turnaround, and the expected maximum APU run duration is customer-configurable, preferably ninety minutes for a maintenance task without an imminent flight.

The machine learning algorithms comprise predictive models configured to predict anomalies including energy overconsumption or failures and to classify events as dual-use or overrun depending on the context. The platform implements a normalization layer standardizing incoming data whatever the aircraft type or supplier format, and dynamically recreates a surrogate parameter from available signals when a parameter is missing or inconsistently reported, so that a uniform dataset is obtained across the fleet. The aeronautical assembly can comprise at least one external equipment configured to communicate with the platform, the external equipment being a ground power unit (GPU) or fixed electrical ground power, provided with at least one sensor measuring an operational parameter and configured to transmit the measured data. Contextual information relating to airports and service providers, including availability of external power and contractual conditions, is ingested by the platform, and the issuing of the APU shutdown command or recommendation is adapted to an operator-defined primary objective selected from cost reduction and greenhouse-gas reduction.

In one implementation, the platform computes, for each turnaround, effective start and stop times and durations of external power connection from the sensor data and stores said durations for auditing of service invoices. The platform generates a real-time alert to a pre-defined list of recipients when an energy overconsumption event or an APU overrun is detected, the alert being accompanied by a recommended action to connect external power and/or to switch off the APU. The alert is preferably accompanied by a multi-channel notification to different users on different interfaces including a secure web portal and a mobile application, each alert card giving direct access to the execution of the recommended action. Geolocation data of the aircraft and of the available external power equipment can be used to propose a nearest or most suitable GPU to connect, according to predefined criteria. In particular, when the platform determines that the APU is used although external power is available at the gate under advantageous contractual conditions, it automatically sends a recommendation to the ground crew to connect the aircraft to the external power and to shut down the APU once a stable external supply is confirmed. The platform displays on the dashboard for each aircraft a current power source, the elapsed duration of use of said source, and a status indicating normal supply, dual-use, or overrun.

The transmission of the control signal to the aircraft interface is performed through a secure communication channel and is restricted to an authorized user profile, an APU shutdown being executed only upon successful authentication and confirmation. The processing further comprises estimating at least one of energy, power and fossil consumption of one or more elements of the aeronautical assembly and computing a greenhouse-gas emissions reduction expected from the APU shutdown relative to continued APU operation. The platform logs each detected event, the issued commands, the confirmations and the resulting APU shutdown or external power connection and generates reconciliation reports comparing recorded external power durations with service invoices.

In another aspect, the invention relates to a non-transitory computer-readable storage medium storing instructions which, when executed by a processor of the digital processing and analysis platform, cause the platform to perform the method as defined herein. In a further aspect, the invention also relates to a digital platform comprising a processor-based computer and a computer storage device, the digital platform configured to communicate on a wireless network and to implement the method for optimizing the energy management and reducing the greenhouse gas emissions of an aeronautical assembly as described above, the platform comprising a data-ingestion and normalization layer, a processing layer implementing machine learning algorithms and a context-recognition and policy engine, an execution layer configured to issue an APU shutdown command as defined herein, and a presentation layer providing the dashboard and the multi-channel notification.

In accordance with an exemplary embodiment of the claimed invention, a computer-implemented method for optimizing energy management and reducing greenhouse gas emissions of an aeronautical assembly comprising at least one aircraft having an auxiliary power unit (APU) is provided. Data measured by the sensors of the aeronautical assembly is collected and transmitted for analysis, in a centralized manner outside the aeronautical assembly, to a digital processing and analysis platform. The digital processing and analysis platform is external to the aeronautical assembly. The digital processing and analysis platform process the data implementing machine learning algorithms to compare at least one state of a parameter of the aeronautical assembly with a predetermined optimal state of the parameter and at least one of the following: to predict a non-optimal state of the parameter and to recommend actions in order to bring the state of the parameter as close as possible to the predetermined optimal state. The processing of the data comprises determining, from the data, a current power-supply state of the aircraft selected from: APU-only supply, external power-only supply, and simultaneous APU and external power supply. Additionally, the processing of the data comprises at least one of: detecting an energy overconsumption event when the simultaneous supply persists beyond a guard time and detecting an APU overrun event when an APU run duration exceeds an expected maximum duration for a recognized maintenance context. Further, the process of data comprises issuing an APU shutdown command associated with the event detected. Information relating to the data processed is displayed on a dashboard accessible via different terminals. The APU is deactivated to decrease the greenhouse gas emissions by at least one of: transmitting, when the aircraft type is configured to accept remote commands, a control signal to an aircraft interface to shut down the APU; and transmitting a shutdown instruction to an authorized ground or flight user terminal and, in response to a received confirmation, issuing the control signal to shut down the APU.

In accordance with an exemplary embodiment of the claimed invention, a non-transitory computer-readable storage medium stores instructions which, when executed by a processor of the digital processing and analysis platform, causes the digital processing and analysis platform to perform the aforesaid computer-implemented method for optimizing energy management and reducing greenhouse gas emissions of an aeronautical assembly comprising at least one aircraft having an auxiliary power unit (APU).

In accordance with an exemplary embodiment of the claimed invention, a digital platform comprising a processor-based computer and a computer storage device is provided. The digital platform communicates on a wireless network and implements the aforesaid method for optimizing energy management and reducing the greenhouse gas emissions of the aeronautical assembly comprising at least one aircraft having an auxiliary power unit (APU). The digital platform comprises a data-ingestion and normalization layer; a processing layer implementing machine learning algorithms and a context-recognition and policy engine; an execution layer configured to issue the APU shutdown command; and a presentation layer providing the dashboard and the multi-channel notification.

In accordance with an exemplary embodiment of the claimed invention, the collection of the data is performed in real time and continuously while the aircraft is parked with engines off, including during a time window in which onboard systems would otherwise neither record nor transmit data. The digital processing and analysis platform executes a software module to interrogate an aircraft interface during the time window and to trigger generation and transmission of the data so as to obtain status events and measured values representative of the power supply of the aircraft and of internal and external equipment activity.

The fundamental concepts of the invention having just been exposed above in their most elementary form, other details and features will emerge more clearly on reading the following description and with regard to the appended drawings, giving by way of non-limiting example, an embodiment of a method for optimizing the energy management and reducing the greenhouse gas emissions of an aeronautical assembly and an associated digital platform, in accordance with the principles of the invention.

### BRIEF DESCRIPTION OF THE FIGURES

The figures are given for purely illustrative purposes for the understanding of the invention and do not limit the scope thereof. The different elements are represented schematically and are not necessarily to the same scale. In all figures, identical or equivalent elements have the same reference numeral.

It is thus illustrated in:

FIG. 1 is a top view of an aircraft parked on the ground and on which external equipment intervenes;

FIG. 2 is a side view of an aircraft with an apparent APU and electrically connected GPU;

Figure is a set of aircraft from the same airline in service on a network of airports served by the airline;

FIG. 4 is a global computer architecture for the implementation of a method according to an exemplary embodiment of the claimed invention;

FIG. 5 shows the main steps of a method in accordance with an exemplary embodiment of the claimed invention;

FIG. 6 is a schematic example of implementation of the method in accordance with an exemplary embodiment of the claimed invention;

FIG. 7 is an example of a web dashboard for viewing the information provided by the method implementation platform in accordance with an exemplary embodiment of the claimed invention;

FIG. 8 is an example of an alert and notification sequence in the case of an anomaly in accordance with an exemplary embodiment of the claimed invention; and

FIG. 9 is an example of a heading being displayed on a mobile application associated with the digital platform in accordance with an exemplary embodiment of the claimed invention.

### DETAILED DESCRIPTION OF EMBODIMENTS

It should be noted that certain technical elements well known to those skilled in the art are described herein to avoid any insufficiency or ambiguity in the understanding of the present invention.

In accordance with an exemplary embodiment of the claimed invention described herein, reference is made to a method for optimizing the energy management and reducing the GHG emissions of an aeronautical assembly, intended mainly for the real-time monitoring of an auxiliary power unit and the like. This non-limiting example is given for a better understanding of the invention and does not exclude the implementation of the method for the real-time monitoring of any other aeronautical equipment whether it is on board the aircraft or on the ground.

In the remainder of the description, the acronyms APU, GPU, ACU and MRO respectively designate an auxiliary power unit, a ground power unit, an air conditioning unit and the maintenance, repair and overhaul. The expression “connected object” refers to an object equipped with means capable of communicating, autonomously, with other objects connected to an Internet-type network.

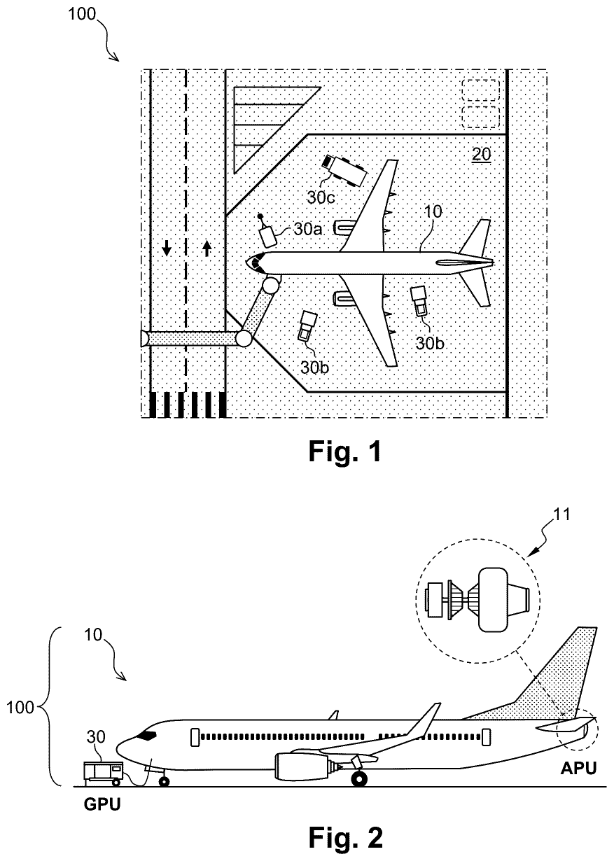

FIG. 1 represents an aircraft 10, of the airliner type, on a parking area (tarmac) of an aerodrome, the aircraft having left the runway after a landing and being prepared to join it again for a take-off. In the meantime, operations are carried out on the aircraft 10, in particular the boarding and/or the disembarkation of travelers, the loading and/or the unloading of freight, the fueling and maintenance.

Concerning the fueling and maintenance operations, appropriate equipment, in the form of vehicles, is rushed in the vicinity of the aircraft 10 in order to perform specific interventions which are previously programmed or, if necessary, decided following contingencies. The necessary interventions can be performed simultaneously by different actors (airport operators, MRO, technical ground crew of the airline operating the aircraft, etc.).

The equipment in question comprises, for example, power groups 30a such as GPUs, utility or support groups (air conditioning, water, etc.) 30b such as ACUs, refueling operators 30c, as well as any other equipment necessary for the aircraft ground handling. This equipment will be generically designated by the reference numeral 30.

In view of their multiple interactions, the aircraft 10 and the equipment 30 evolve in a complex system and can be grouped within an aeronautical assembly 100 allowing the implementation of a method according to the invention to optimize the energy management of each element of said assembly.

The aeronautical assembly 100 can be defined in different manners depending on the industrial objectives targeted by the method of the invention.

The aeronautical assembly 100 can either be fixed and always comprise the same elements (same aircraft and same equipment), or variable and changes elements according to specific rules. In the latter case, the aeronautical assembly 100 can for example be defined with reference either to a given zone, delimited on a given aerodrome, and therefore comprise all elements contained in said zone, either to a given airline, or to an airline alliance, and include all active aircraft in the fleet, either at a given airport or at a given airport network. The aeronautical assembly 100 can also be defined by combining fixed elements and variable elements.

In all cases, the aeronautical assembly 100 must comprise at least one aircraft 10. Therefore, the aeronautical assembly 100 necessarily comprises on-board systems of the aircraft 10 such as the APU, which will be referred to as “internal equipment” as opposed to the aforementioned “external equipment” (GPU, ACU, etc.).

FIG. 2 represents an example of an aeronautical assembly 100 comprising an aircraft 10, an APU 11 of the aircraft, as internal equipment, and a GPU 30 as external equipment. The GPU is herein electrically connected to the aircraft 10.

FIG. 3 represents a plurality of aircraft 10a to 10i operated by an airline on a network of airports A1 to A5 served by said airline. Among the represented aircraft, some are in flight (10c, 10g and 10h) and others on the ground, parked in certain airports (A1, A3 and A5).

The aircraft and the airports of the simplified example of FIG. 3 can be grouped in an aeronautical assembly for the implementation of the method of the invention. The complexity of such an assembly and the amount of data it is capable of generating increases with the number of elements (aircraft and airports). Nevertheless, the implementation of the method of the invention on such an assembly is only a multiplication of its implementation on each of the constituent elements of the assembly taken independently. Consequently, the description of the method can be made from a simplified aeronautical assembly such as that of FIGS. 1 and 2, while remaining valid for a more complex aeronautical assembly, within the limits of the conditions defined above.

The method for optimizing the energy management of an aeronautical assembly mainly allows exploiting data collected from different sources (aircraft, internal/external equipment, airports, and possibly airlines) to provide users with an effective decision support tool allowing them to considerably improve their interventions, especially from a logistical point of view, and limiting as much as possible any unnecessary energy consumption in the aeronautical assembly.

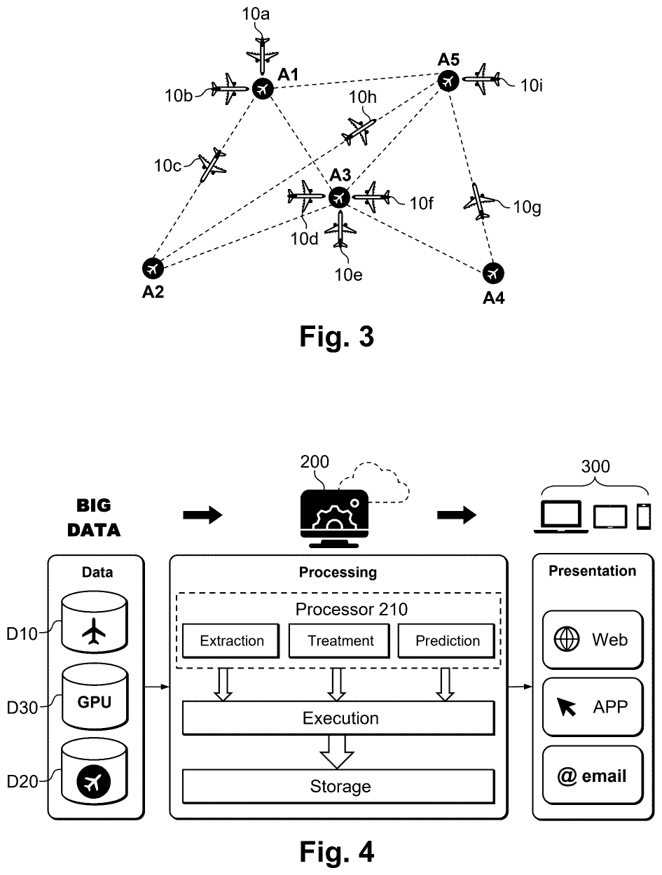

FIG. 4 represents a global computer architecture allowing exploiting the data according to the method of the invention, the latter being organized into three paradigms: the collection of the data, the processing of the data and the presentation of information in order to elicit the action of a user.

The data collection is done by means of sensors installed on the elements of the aeronautical assembly. For example, the internal equipment of an aircraft has sensors which measure various physical, technical or other parameters.

The parameters measured by the sensors of the aeronautical assembly are sent, in real time or at regular time intervals, to an off-board analysis platform 200, by means of a wireless network. At the request of the processor 210 of said platform 200, parameters are transmitted thereto by adapted servers. The processor 210 then performs a series of calculations by executing dedicated programs. Among the programs installed on the platform 200, some carry out a simple presentation, interactive or not, of the data collected, others carry out a multifaceted interpretation and representation of the data, and still others compile artificial intelligence algorithms to predict information not available as is, in order to provide the necessary recommendations to optimize the energy consumption and the emissions of the aeronautical assembly.

Thus, an “intelligent” control of the aeronautical assembly 100, in particular in terms of energy management, can be carried out according to the method of the invention.

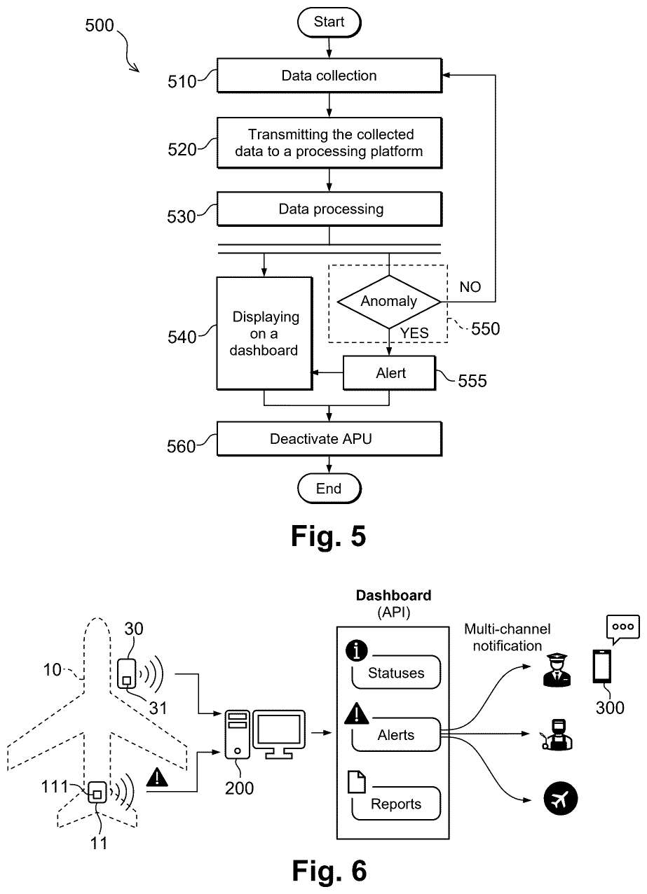

FIG. 5 represents the main steps of a method for optimizing the energy management of an aeronautical assembly, this method comprising:
an initial step 510 of data collection;
a step 520 of transmitting the collected data to a processing platform;
a data processing step 530;
a step 540 of displaying the processed data via a dedicated interface;
a conditional anomaly detection step 550;
a real-time alert step 555 in the case of an anomaly; and
a step 560 of deactivating the APU to decrease the greenhouse gas emissions or other appropriate actions.

FIG. 6 illustrates an example implementation of the steps of the above method in the case of an aeronautical assembly comprising an aircraft 10 and at least one external equipment 30 such as a GPU, said aircraft comprising at least one internal equipment 11 such as an APU.

The internal equipment 11 and the external equipment 30 each comprise one or more sensors 111 and 31 measuring the operating parameters of the equipment.

The sensors of the equipment perform measurements in real time and continuously, and transmit the collected data to the digital processing platform 200 via any adapted network such as a network compatible with the Internet of Things (IoT). To this end, the equipment of the aeronautical assembly is capable to communicate on such a network, or includes, integrated, “intelligent” electronic boxes which allows both collecting the measured data and transmitting them.

In a particularly advantageous manner, the invention bridges the ground-phase data gap by enabling the aircraft to generate and share operating information while parked, even when the engines are off. For this purpose, a connected module publishes, in real time, status events and measured values representative of the aircraft power supply and of the internal and external equipment activity, thereby providing continuous visibility over ground operations. The platform 200 thus records, with timestamps, start and stop events of the APU and of any connected external power source, and can compute effective durations of use for each source.

After processing them by the processor of the platform 200, the data is displayed on a dashboard in a usable form, preferably intuitive and simplified, by using data mining techniques for example. This dashboard can be designed as an application programming interface API and accessible from several terminals 300 such as personal communication devices (smartphones, digital tablets, computers, etc.) represented in FIG. 4.

The dashboard allows compiling the essential information for decision support concerning the energy management operations of the aeronautical assembly. This information is, among other things, presented in the form of equipment statuses, alerts, automatically generated reports, etc. For example, the dashboard comprises the history of the emissions and savings made, allows making future projections on different parameters, allows the user to record the root causes of uses detected as sub-optimal to target the malfunctions to be resolved by the Pareto principle or a similar principle.

Due to their criticality, the alerts are for example notified in real time to several actors simultaneously (pilots, MRO operators, airports). This multi-channel notification of alerts allows mastering the risks relating to the anomalies having triggered said alerts and ensuring a certain redundancy in the verification, especially since double verification is often required with the air authorities.

With reference to FIG. 5, the initial step 510 of collecting data consists in bringing together a large amount of data (big data) from different available sources. Firstly, the data originates from the considered aeronautical assembly and comprises the parameters measured in real time and continuously by the sensors of the different “connected” equipment (APU, GPU, ACU, etc.), the data specific to air traffic, the data from the airports, the data from the airlines, as well as any other contextual data (weather, energy tariffs, etc.) necessary for the execution of specific calculation models during the processing step 530.

The main data sources are represented in FIG. 4 and combine aircraft data D10 (the latter naturally comprising internal equipment data), external equipment data D30 and airport data D20.

Of course, some data can be collected in deferred time, at regular time intervals or at the request of the user.

The collected data is then transmitted to the digital processing platform, said platform includes physical or cloud servers accessible on a suitable communication network.

The data transmission step 520 is preferably carried out in real time for optimal tracking of the changes in the different parameters of the aeronautical assembly. This transmission is necessarily carried out on secure channel or channels and may make use signal encoding or encryption techniques, or even blockchain security also allowing timestamping the data transmitted before the processing thereof.

To cope with the heterogeneity of fleets, the digital platform 200 comprises a normalization layer that standardizes the incoming data whatever the aircraft type or the supplier format. When a parameter is missing or inconsistently reported for a given aircraft, the platform recreates a surrogate parameter from the available signals so that a uniform dataset is obtained across all commercial aircraft. This homogenized dataset allows the subsequent predictive models and decision rules to be applied consistently at airline or airport-network scale.

The data processing step 530 consists in executing a series of calculations and analyses in order to make the collected data usable and allow the user to take the necessary actions to optimize the energy management of the aeronautical assembly.

This processing step is implemented by the processor, of the computer type, of the digital platform, implementing, among others, artificial intelligence algorithms to carry out predictive analyses.

In accordance with an exemplary embodiment of the claimed invention, the digital processing and analysis platform 200, implementing machine learning algorithms, processes the data to compare at least one state of a parameter of the aeronautical assembly with a predetermined optimal state of the parameter. Additionally, the digital processing and analysis platform process the date to predict a non-optimal state of the parameter and/or to recommend actions in order to bring the state of the parameter as close as possible to the predetermined optimal state.

More specifically, machine learning models allows predicting the occurrence of anomalies such as energy overconsumption or failures in the aeronautical assembly, but also recommending actions based on historical data and interventions available for said assembly or from another aeronautical assembly.

In accordance with an exemplary embodiment of the claimed invention, the processing by the digital processing and analysis platform 200 further comprises: (i) determining, from the data, a current power-supply state of the aircraft selected from: APU-only supply, external power-only supply, and simultaneous APU and external power supply; (ii) at least one of: detecting an energy overconsumption event when the simultaneous supply persists beyond a guard time and detecting an APU overrun event when an APU run duration exceeds an expected maximum duration for a recognized maintenance context; and (iii) issuing an APU shutdown command associated with the event detected.

In accordance with an exemplary embodiment of the claimed invention, the processing by the digital processing and analysis platform 200 deactivates the APU to decrease the greenhouse gas emissions (i) by transmitting, when the aircraft type is configured to accept remote commands, a control signal to an aircraft interface to shut down the APU and/or (ii) by transmitting a shutdown instruction to an authorized ground or flight user terminal and, in response to a received confirmation, issuing the control signal to shut down the APU.

In accordance with an exemplary embodiment of the claimed invention, the processing by the digital processing and analysis platform 200 further comprises a context recognition of each turnaround, distinguishing in particular a maintenance context from a passenger turnaround with or without an imminent flight. Based on the recognized context, a customer-configurable policy engine defines expected operating windows for specific equipment, for instance a maximum APU run duration when the aircraft is parked for maintenance. When the measured behavior exceeds the expected window, the platform 200 classifies the situation as an overrun or as an energy overconsumption event and triggers the associated workflow, including alerting and recommendation.

The data processing step 530 also allows executing calculations based on standard models of energy consumption, emission of polluting particles (CO₂, NOₓ), and the like, for example to estimate operating costs (fuel, taxes, etc.) and recommend actions to reduce said costs.

The different operated calculations can use geolocation data from the elements of the aeronautical assembly in order to refine the desired optimization

For example, when the intervention of a GPU is necessary on an aircraft, knowing the exact coordinates of said parked aircraft and the different available GPUs allows choosing the closest GPU or the one fulfilling specific criteria according to a given collaborative model.

The processing also determines, in real time, the power source effectively supplying the aircraft. By combining the APU status with measurements reported by the aircraft and by the external equipment, the platform 200 can discriminate between exclusive APU supply, exclusive external power supply, or simultaneous APU and external power supply. To avoid false positives during a normal transfer of loads, a guard timer is applied; only if the simultaneous supply persists beyond a parameterizable waiting period (for example fifteen minutes) is the situation flagged as dual use and handled as an overconsumption event.

Contextual information relating to airports and service providers, including the availability of external power and contractual conditions such as pricing schedules or free-of-charge windows, can be ingested by the platform 200. The decision logic then adapts the recommendations according to the operator's primary objective (cost reduction or greenhouse-gas reduction) and proposes the most favorable action. By way of example, when external power is available under advantageous conditions, the platform recommends connecting the aircraft to the GPU or fixed electrical ground power and shutting down the APU once a stable external supply is confirmed.

The activity data of an element of the aeronautical assembly can be, in turn, extracted from the measurements of the movement of said element (displacement on the tarmac for example) or, when the latter is stationary, from the measurements of a vibration sensor installed in the element and set to a vibration threshold corresponding to an effective activity.

The vibration measurements of an element, an APU for example, can also be used to predict anomalies or failures by analyzing the recorded vibration profiles.

During the data processing step, different algorithms can be used, among which predictive algorithms such as ordinary least squares, regularization methods, Lasso method, a logistic regression, a random forest, a gradient boosting, a support vector machine, a stochastic gradient algorithm, k-K-nearest neighbor method; and data classification and partitioning algorithms such as K-means, Gaussian mixture model, a spectral partitioning, the DBSCAN algorithm, interactive partitioning, isolation forest for anomaly detection, etc.

The results of the different processing operations are then displayed on the dashboard during the display step 540.

Advantageously, the dashboard highlights ground-operation indicators, notably the current power source of each aircraft, the elapsed duration of use of that source, and the possible detection of a dual-use state. Each aircraft view is accessible through a secure web address so that the information can be consulted on any device without prior installation, while keeping user authentication and authorization management. Alert cards provide a direct access to the recommended actions associated with the detected event.

The dashboard is accessible from different terminals and allows different users to access information in real time.

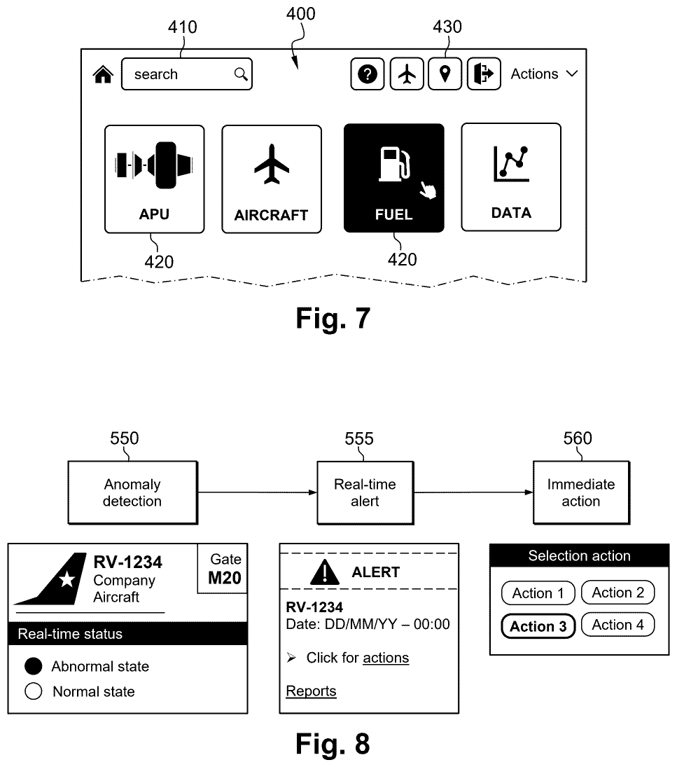

FIG. 7 represents an example of a home page of a dashboard 400 accessible from a web page (secure access to a user space).

The dashboard 400 is a graphical interface adapted to each user and includes components to facilitate the navigability, the access to information and the tracking.

Generally, this dashboard includes the main headings of the energy management, indicated by tabs 420 with pictograms for example, herein APU, aircraft, fuel and data. The dashboard 400 can further have a search bar 410 for a quick access to specific data, additional customizable buttons 430, as well as any other component or interface tool simplifying the use of the dashboard.

Thus, the dashboard allows accessing the different performed data processing, but above all monitoring in real time the cases of alerts and offering the user immediate communication means to manage these alerts.

In an illustrative scenario in maintenance, the platform detects that the APU is running while no flight is scheduled before the next day. The recognized context sets an expected APU-on duration defined by the customer. If the measured duration reaches this threshold without a corresponding shutdown event, the situation is classified as an APU overrun and a real-time alert is issued to a pre-defined list of recipients so that an operator can intervene and stop the APU.

In another scenario frequently observed at the gate, the aircraft arrives with the APU active and the ground crew connects the external power. The platform identifies that both sources feed the aircraft and starts the above-mentioned guard timer to allow the normal transfer. If, after the waiting period, the APU remains on while external power is stable, an automated alert is sent to flight operations and the recommended action indicates to switch off the APU to avoid unnecessary consumption.

In a further scenario, the platform detects that the APU is used although external power is available at the gate under advantageous contractual conditions for the operator. By correlating aircraft status with airport contextual data, the platform automatically sends a recommendation to the ground crew to connect the aircraft to the GPU or fixed power so as to benefit from the contractual conditions and to limit fuel use and emissions.

FIG. 8 gives an example of display windows accompanying the management of an alert, from the detection step 550 to the action step 560. The alert can also be notified on different channels for the same user, for example both on a mobile application and by a message on a mobile telephone network (sms) to overcome the absences or interruptions of internet connection, a connection necessary for the operation of the mobile application.

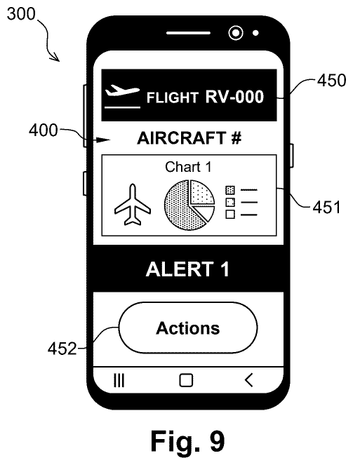

FIG. 9 finally gives an example of a dashboard 400 for a mobile application, displayed on a smartphone 300. In this case of reduced display, the dashboard preferably displays a single heading per window for a better readability. Herein a pre-flight section 450 is displayed with the references of the flight and the aircraft. An information box 451 can be provided to show relevant data directly linked, for example, to a sent alert. An active menu 452 for choosing actions can also be displayed on the screen in the case of an alert.

The person skilled in the art easily understands that the dashboard can be adapted according to the need of each user.

Beyond real-time decision support, the platform provides an auditing function for external power services. Using the sensor data and the decision logic described above, the system determines the effective start and stop times of the external power connection and stores the corresponding durations for each turnaround. These records allow the operator to compare the services actually consumed with the invoices received from airports or service providers and to generate reconciliation reports.

It clearly emerges from the present description that some steps of the method can be changed, replaced or deleted and that some adjustments can be made to the implementation of this method according to the targeted objectives, without thereby departing from the scope of the invention.

1. A computer-implemented method for optimizing an energy management and reducing greenhouse gas emissions of an aeronautical assembly comprising at least one aircraft having an auxiliary power unit (APU), the method comprising:
collecting data from the aeronautical assembly, the data comprising data measured by sensors of the aeronautical assembly;
transmitting the data collected for analysis, in a centralized manner outside the aeronautical assembly, to a digital processing and analysis platform, external to the aeronautical assembly;
processing the data by the digital processing and analysis platform, implementing machine learning algorithms, to compare at least one state of a parameter of the aeronautical assembly with a predetermined optimal state of the parameter and at least one of the following: to predict a non-optimal state of the parameter and to recommend actions in order to bring the state of the parameter as close as possible to the predetermined optimal state;
wherein the processing further comprises:
(i) determining, from the data, a current power-supply state of the aircraft selected from: APU-only supply, external power-only supply, and simultaneous APU and external power supply;
(ii) at least one of: detecting an energy overconsumption event when the simultaneous supply persists beyond a guard time and detecting an APU overrun event when an APU run duration exceeds an expected maximum duration for a recognized maintenance context; and
(iii) issuing an APU shutdown command associated with the event detected;
displaying information relating to the data processed on a dashboard accessible via different terminals; and
deactivating the APU to decrease the greenhouse gas emissions by at least one of: transmitting, when the aircraft type is configured to accept remote commands, a control signal to an aircraft interface to shut down the APU; and transmitting a shutdown instruction to an authorized ground or flight user terminal and, in response to a received confirmation, issuing the control signal to shut down the APU.

2. The method of claim 1, wherein the collection of the data is performed in real time and continuously while the aircraft is parked with engines off, including during a time window in which onboard systems would otherwise neither record nor transmit data, and wherein a software module executed by the digital processing and analysis platform is configured to interrogate an aircraft interface during said time window and to trigger generation and transmission of said data so as to obtain status events and measured values representative of the power supply of the aircraft and of internal and external equipment activity.

3. The method of claim 1, wherein the determining of the current power-supply state combines APU status with measurements reported by the aircraft and by at least one external equipment, so as to discriminate between exclusive APU supply, exclusive external power supply, or simultaneous supply.

4. The method of claim 1, wherein the guard time applied before declaring the simultaneous supply as an energy overconsumption event is equal to fifteen minutes and configurable.

5. The method of claim 1, wherein the recognized maintenance context distinguishes a maintenance context from a passenger turnaround, and an expected maximum APU run duration is ninety minutes for a maintenance task without an imminent flight and customer-configurable.

6. The method of claim 1, wherein the machine learning algorithms comprise predictive models configured to predict anomalies including energy overconsumption or failures and to classify events as dual-use or overrun depending on the context.

7. The method of claim 1, wherein the digital processing and analysis platform implements a normalization layer standardizing incoming data whatever the aircraft type or supplier format and dynamically recreates a surrogate parameter from available signals when a parameter is missing or inconsistently reported, so that a uniform dataset is obtained across the fleet.

8. The method of claim 1, wherein the aeronautical assembly comprises at least one external equipment configured to communicate with the digital processing and analysis platform, the external equipment being a ground power unit (GPU) or fixed electrical ground power, provided with at least one sensor measuring an operational parameter and configured to transmit the measured data.

9. The method of claim 1, wherein contextual information relating to airports and service providers including availability of external power and contractual conditions is ingested by the digital processing and analysis platform; and wherein an issuance of the APU shutdown command or instruction is configured to an operator-defined primary objective selected from cost reduction and greenhouse-gas reduction.

10. The method of claim 1, wherein the digital processing and analysis platform computes, for each turnaround, effective start and stop times and durations of external power connection from sensor data and stores said durations for auditing of service invoices.

11. The method of claim 1, wherein the digital processing and analysis platform generates a real-time alert to a pre-defined list of recipients when the energy overconsumption event or the APU overrun is detected, the alert being accompanied by a recommended action comprising at least one of: to connect external power and to switch off the APU.

12. The method of claim 11, wherein the alert is accompanied by a multi-channel notification to different users on different interfaces including a secure web portal and a mobile application, each alert card giving direct access to the execution of the recommended action.

13. The method of claim 1, wherein geolocation data of the aircraft and of the available external power equipment are used to propose a nearest or most suitable GPU to connect, according to predefined criteria.

14. The method of claim 1, wherein the digital processing and analysis platform determines that the APU is used although external power is available at a gate under advantageous contractual conditions and automatically sends a recommendation to the ground crew to connect the aircraft to the external power and to shut down the APU once a stable external supply is confirmed.

15. The method of claim 1, wherein the digital processing and analysis platform displays on the dashboard for each aircraft a current power source, the elapsed duration of use of said current power source, and a status indicating normal supply, dual-use, or overrun.

16. The method of claim 1, wherein the transmission of the control signal to the aircraft interface is performed through a secure communication channel and is restricted to an authorized user profile, an APU shutdown being executed only upon successful authentication and confirmation.

17. The method of claim 1, wherein the processing further comprises estimating at least one of energy, power and fossil consumption of one or more elements of the aeronautical assembly and computing a greenhouse gas emissions reduction expected from the APU shutdown relative to continued APU operation.

18. The method of claim 1, wherein the digital processing and analysis platform logs each event detected, the commands issued, the instruction issued, the confirmations and the resulting APU shutdown or external power connection, and generates reconciliation reports comparing recorded external power durations with service invoices.

19. A non-transitory computer-readable storage medium storing instructions which, when executed by a processor of the digital processing and analysis platform, cause the digital processing and analysis platform to perform the method of claim 1.

20. A digital platform comprising a processor-based computer and a computer storage device, the digital platform configured to communicate on a wireless network and to implement the method for optimizing the energy management and reducing the greenhouse gas emissions of the aeronautical assembly of claim 1, the digital platform comprising:
a data-ingestion and normalization layer;
a processing layer implementing machine learning algorithms and a context-recognition and policy engine;
an execution layer configured to issue the APU shutdown command; and
a presentation layer providing the dashboard and the multi-channel notification.
